(19) United States
(12) Patent Application Publication
(10) Pub. No.: US 2002/0151239 A1
(43) Pub. Date: Oct. 17, 2002

(54) Not-sew seamless technology

(76) Inventor: Eric Aerts, Maplewood, NJ (US)

Correspondence Address: PENNIE AND EDMONDS, 1155 AVENUE OF THE AMERICAS, NEW YORK, NY, 100362711

(21) Appl. No.: 10/001,286

(22) Filed: Nov. 30, 2001

(30) Foreign Application Priority Data
May 11, 2000 (US) PCT/US00/12947

(51) Int. Cl. B32B 27/04; B32B 5/02; B32B 27/12; D03D 15/00; D03D 25/00

(52) U.S. Cl. 442/149; 442/181

(57) ABSTRACT

A method and system for designing and making garments is disclosed that does not require sewing. This method and system makes possible a seamless garment finish that is more comfortable than a finish having seams and other imperfections due to the need to tuck/sew edges and joints. The disclosed seamless technology employs a thin film of adhesive that is preferably an ether-based polyurethane although other adhesives are acceptable. This adhesive is prelaminated on at least one surface prior to lamination to another surface under conditions to control adhesion, stretch, breathability, and longevity of the garment. Lamination also allows for a seamless finish without fraying at the edges resulting in even displacement of pressure against the skin of the wearer for greater comfort. Disclosed seamless manufacturing techniques can be applied in an iterative fashion to manufacture inserts and support elements that are subsequently incorporated into laminated garments following additional lamination steps.

### FIELD OF THE INVENTION

The present invention relates generally to manufacturing of garments via fabric lamination and an intermediate pre-laminating step and without requiring stitching. More specifically, the laminate fabric has particular utility in conjunction with women's undergarments, such as panties and brassieres as well as undergarments in general by providing cost efficient construction of reinforced garments with desired texture, function, and porosity.

### NOTICE REGARDING COPYRIGHTED AND TRADEMARKED MATERIAL

A portion of the disclosure of this patent document contains material in the drawings subject to copyright protection. In addition, NOT-SEW™ SEAMLESS TECHNOLOGY, and “nothing smoother” are trademarks and slogans variously protected against use in a manner interfering with the business of the owner of said marks. The assignee of the marks has no objection to the facsimile reproduction by anyone of the patent document or the patent disclosure as it appears in the Patent and Trademark Office file or records, but otherwise reserves all rights whatsoever including said copyrights.

### BACKGROUND OF THE INVENTION

The use of laminates and other reinforcing materials to provide additional support or control at selective portions of an undergarment is generally well known. For example, Prunesti et al. U.S. Pat. No. 4,776,9116 and Bell et al. U.S. Pat. No. 4,701,964 disclose the utilization of a powdered adhesive material. The utilization of the silk screen for applying the powdered adhesive limits the manufacturing speed and overall efficiencies in the fabrication of such a laminate and the resultant undergarments.

The selective reinforcement of portions of a foundation garment by an intermediate plastic layer having adhesive qualities is also shown in Byrne U.S. Pat. No. 3,228,401. In that patent the plastic reinforcing material is applied to the fabric as a flowable paste that flows into the fabric to embed the individual threads forming the fabric. The flowing of the plastic into the fabric results in an undesired stiffening of the fabric, changing its hand, a technical term for the feel, softness and appeal of the fabric, resulting in irritation to the skin of the wearer. Similarly, U.S. Pat. Nos. 3,225,768 and 3,320,346 issued to Galitzki et al show a cloth and plastic laminate for a breast support such as a bathing suit with the elastomeric polyethylene polymer bonding two fabrics together with the plastic flowing within the interstices of the fabric; Likewise, Storti U.S. Pat. No. 3,327,707 uses an elastomeric adhesive to secure a stomach control panel to a foundation garment with the adhesive flowing into the girdle fabric to lock itself around the individual stretch yams.

The utilization of stiffening panels or other elements within undergarments or other apparel products is also generally known, for instance, U.S. Pat. No. 3,021,844, issued to Flagg et al., shows a brassiere reinforced in the breast cup area by a stiffening liner; U.S. Pat. No. 3,750,673 is similarly directed to a brassiere having a plurality of plastic stays positioned below the cup portion; U.S. Pat. No. 2,915,067 illustrates stiffening elements adhesively secured to the lower cup portion of a brassiere, or waist band of a girdle; U.S. Pat. No. 4,172,002 teaches laminating a patch of mold able fabric as a brassiere undercup support element.

Brassieres present additional manufacturing challenges due to issues related to comfort, appearance and marketing. Typically, brassieres may be sheer, lined, or padded for reasons of appearance and comfort. There are essentially two varieties of lined or padded bras—cut-and-sew, and molded. The cut-and-sew variety creates the shape of its cup and padding by assembling pre-cut components while molded brassieres are provided cups by heat or pressure based shaping of materials and pads. Sheer or unlined brassieres have no lining whatsoever often resulting in nipples showing through, a quality that is often regarded with disfavor by many, but not all, customers. Lined brassieres are both more comfortable than sheer brassieres and are better at concealing nipples while retaining a more realistic look when worn. Typically lined brassieres contain an additional layer that is one eighth to a quarter inch thick. Padded brassieres are heavier than lined brassieres and are often designed to enhance the apparent size of the bust or provide increased comfort to the wearer. Padded brassieres are almost always sewn with the undesirable feel of sewn edges and inserts.

With regard to brassieres, hanger appeal refers to the customer's first impression when they see the garment on the hanger at retail. In particular, a lightly lined brassiere has greater hanger appeal than an unlined version specifically because the unlined bras droop in the breast due to the lack of support, whereas the lined version is better at holding its shape. Thus, the consumer can immediately envision how it will look when worn without having to try it on. Thus, a manufacturing challenge is to make a lined brassiere without uncomfortable seams that is economical to make, perspiration resistant, does not discolor with use or light and still provide a good hand and hanger appeal. To this end lamination has been attempted unsuccessfully for both lined and padded brasseires.

U.S. Pat. No. 4,372,321 provides a brassiere having a unitary molded breast cup including an intermediate lower cup support panel adhesively bonded to the cup by a polyester hot melt adhesive typically applied through a screen that allows dotted coverage of the surface. Such an adhesive pattern makes the orientation of the adhesive a factor in controlling the overall laminate elongation characteristics. U.S. Pat. No. 3,317,645 discloses another method for forming a laminate or molded article such as brassiere cups with an intermediate plastic layer while U.S. Pat. Nos. 4,375,445 and 4,419,997 are directed to molded cup brassiere in which the cup is formed of a laminate consisting of two layers of stretchable material which include a non-stretchable crown portion, a substantially non-stretchable longitudinal cup portion and a unitary multi-directional stretchable periphery portion. These attempts fail at providing the lightness associated with lined brassieres while requiring the use of plastic cups and the like.

Lining or padding is typically made from either fiber or foam that simply lack the stretch needed to bubble mold. Therefore, when making a padded, seamless bra, manufacturers have historically turned to form molding.

Form molding does not require much stretch at all; instead, male and female molds are heated and pressed together to essentially melt the foam or fiber padding into the desired shape. This method is however, not suitable for providing cups in a completed bra since the pads are molded first, and then assembled into the garment later. The reason for this limitation is that once the underwire has been placed into the bra, e.g., as channeling, it is almost impossible to place the bra within the male and female molds in a manner that will not damage the garment by placing stress on the underwire. The molds tend to press against the wires in a manner that unacceptably increases the likelihood of tearing the outer fabric.

Some problems in providing thinner and differential lamination to manufacture flexible laminated fabrics have been addressed. U.S. Pat. No. 3,383,263 is directed to a method for preparing a fabric laminate by laminating two fabrics by means of regularly recurring spaced geometric units of substantially dry adhesive film sandwiched between the outer fabric surfaces, with the result laminate having a raised pattern portion as determined by the adhesive pattern. U.S. Pat. No. 3,497,415 forms a laminate including fabrics of different elasticity secured together with a conventional adhesive, such that the laminate characteristics are primarily determined by the elasticity of the two fabric layers and U.S. Pat. No. 4,135,025 teaches varying the stretch characteristics of a fabric by selective insertion of different warp and weft threads into the fabric.

Similarly, aforementioned U.S. Pat. No. 5,447,462, incorporated herein in its entirety by reference, discloses fabric laminates formed such that both the characteristics and orientation of the adhesive layer, primarily a polyamide material, plays an important role in the laminate elongation characteristics. The adhesive comprises an integral adhesive, web which has differential elongation characteristics, characterized as offering different magnitudes of resistance to elongation when subjected to distortion in its different directions. Moreover, the adhesive web is confined to between the fabric layers without any appreciable penetration into the individual fabrics forming the laminate. The use of such an adhesive web is undesirable from the perspective of low-cost, high quality manufacturing due to the required handling during manufacturing, the desired stability of the adhesive upon repeated exposure to moisture and perspiration and introduction of pores without employing excessively thick adhesive layers.

In view of the above discussion it is clear that laminated brassieres are difficult to manufacture due to the various restrictions and desirable properties. For instance, this task is made difficult due to the presence of support wires in channeling in laminated brassieres that further requires that any cup molding step not stress or stretch the fabric excessively or damage the garment irreparably.

Therefore, it is desirable to improve manufacturing techniques and reduce cost for the mass production of laminated garments, typically including laminated support panels, e.g., panties and brassieres and other undergarments, with better adhesives, inserts and manufacturing procedures to resist damage due to garment wear and tear caused by exposure to moisture, heat and perspiration while providing superior feel and comfort to a person wearing the garment.

### SUMMARY OF THE INVENTION

A method and system for designing and making garments is disclosed without requiring sewing to either join or finish edges. This method and system, referred to as Not-Sew™ technology makes possible several advantages properties. For instance, a seamless garment finish is more comfortable than a finish having seams and other imperfections due to the need to tuck/sew edges and joints. Seamless undergarments are less apparent under close fitting outer clothing, thus, creating a more pleasant appearance and greater aesthetic appeal. In addition, lamination allows for the edges of a garment to remain unsewn by providing a fraying resistant seamless finish due to the presence of the adhesive. This results in even displacement of pressure against the skin of the wearer and greater comfort than other seamless garments. Not-Sew™ manufacturing techniques are more efficient and less costly than traditional sewing techniques. The Not-Sew™ technology employs a film of adhesive that is preferably an ether-based polyurethane although other adhesives are acceptable. This adhesive is prelaminated and laminated under conditions to control adhesion, stretch, breathability, and longevity of the garment.

### DESCRIPTION OF THE DRAWINGS

FIG. 1 graphically presents data on comparison of hydrolytic stability measured by tensile strength of polyester-based thermoplastic polyurethane, polyester-based thermoplastic polyurethane with enhanced hydrolytic stability, polyether-based thermoplastic polyurethane with flame retardation, or polyether-based thermoplastic polyurethane;

FIG. 2 graphically presents data on comparison of hydrolytic stability measured by elongation of polyester-based thermoplastic polyurethane, polyester-based thermoplastic polyurethane with enhanced hydrolytic stability, polyether-based thermoplastic polyurethane with flame retardation, or polyether-based thermoplastic polyurethane;

FIG. 3 graphically presents data on comparison of hydrolytic stability measured by 100% tensile modulus of polyester-based thermoplastic polyurethane, polyester-based thermoplastic polyurethane with enhanced hydrolytic stability, polyether-based thermoplastic polyurethane with flame retardation, or polyether-based thermoplastic polyurethane;

FIG. 4 graphically presents an Arrhenius plot of data on hydrolytic stability of thermoplastic polyester-based polyurethane resin;

FIG. 5 graphically presents an Arrhenius plot of data on hydrolytic stability of thermoplastic polyether-based polyurethane resin;

FIG. 6 illustrates the preparation of an example insert by a method that includes lamination following pre-lamination;

FIG. 7 illustrates the preparation of a center-front-stabilizer channeling requiring placement of wires and support elements into a laminated support piece manufactured by pre-lamination followed by placement of the support pieces and then lamination;

FIG. 8 illustrates the structure of a center-front-stabilizer channeling prepared by lamination in an embodiment of the invention;

FIG. 9 illustrates an example pre-lamination setup in an embodiment of the invention;

FIG. 10 shows half of an example brassier manufactured in accordance with the invention;

FIG. 11 shows an example lining for a brassiere cup prior to bubble molding;

FIG. 12 shows another example lining for a brassiere cup prior to bubble molding;

FIG. 13 shows a bubble molding process for creating a cup in a brassiere; and

FIG. 14 shows an example brassier manufactured in accordance with the invention.

### DETAILED DESCRIPTION OF THE INVENTION

Lamination based manufacturing of garments although known in the art, is not as widely used as might be expected in view of the labor intensive nature of standard sewing techniques. One of the reasons is that the nature of the known adhesives was not suitable to provide long-lasting comfortable garments. Plastic does not allow for ready exchange of gases resulting in excessive buildup of moisture, odors and provides a less than desirable feel for the wearer. Other adhesives are susceptible to hydrolysis, particularly in undergarments, upon exposure to sweat, and other bodily fluids. Applicants have also determined that adhesives in the form of films are preferable to adhesives in the form of webs for laminating fabrics together. This is due to, in part, the improved consistency in adhesion following lamination made possible by films.

On the other hand, lamination makes possible easy construction of reinforced garments such that the reinforcement is in areas in need of reinforcement. Such reinforcement does not make the garment excessively bulky while providing desirable fabric feel close to the skin. The outer layer of an exemplary laminated garment can be selected for other properties such as removing moisture, appearance and the like without compromising on the feel of the garment or its durability. The glue that holds this all together is the adhesive used to laminate the plurality of layers together.

Aforementioned art describes various laminated garments and adhesives that are deficient in one or more respects. Applicants have discovered that use of thin films of adhesives, such as polyurethanes, is particularly suitable for manufacturing laminated garments. Preferably the thickness of the thin film is at least 0.5 mils and less than 20 mils. and ranges there between. More preferably the thickness of the film is from 0.5 mils to 2.0 mils. Even more preferably the thickness of the film is from 1.0 mils to 5.0 mils and most preferably the thickness of the film is from 1.0 mils to 1.5 mils. The use of a thin film enables pre-lamination, as described later, and adhesion while maintaining porosity, stretch, softness of hand, and avoiding imparting a bulky feel to the laminated garment.

Suitable films and webs of adhesives for practicing various embodiments of the invention exhibit high resistance to moisture and perspiration, in addition to possessing elastomeric and thermoplastic properties. An example film comprises ether-based polyurethane, and suitable lubricants, if any. The proportion of lubricants in such films is typically less than 1%, preferably less than 0.5% and even more preferably less than 0.1%. The preferred lubricant resists discoloration caused by exposure to UV or moisture/perspiration without intending to be bound by theory. An example film comprising a suitable lubricant is the “NOT-SEW ADHESIVE FILM” manufactured and supplied by JPS Elastomerics of Holyoke, Mass. (also supplied as item #1310). Additional exemplary films comprise treated ester-based polyurethane and suitable lubricants, if any. The films can be composites of various thermoplastic materials. Preferably the adhesive film comprises at least 50% ether-based polyurethane, even more preferably 90% ether-based polyurethane and most preferably at least 99% ether-based polyurethane.

Resistance to moisture, perspiration, and hydrolysis is desirable in laminated garments and particularly in undergarments. Hydrolytic stability testing of polyester-based polyurethane and polyether-based polyurethane adhesives revealed that polyether-based polyurethane is preferable to polyester-based polyurethane. Polyurethanes are a thermoplastic material that exhibit elastomeric properties although they do not have internal cross-links to any appreciable degree. This makes them suitable for use as adhesives in lamination, especially in view of the tackiness of ether-based polyurethanes at suitable temperatures below their melt points, or glass transition temperatures. Typical glass transition temperatures are greater than or about 200° F. and may often be as high as 375° F. Of course, a consideration is the stability of the fabric being laminated at the temperatures for making the adhesive tacky or actually melt. Next, the resistance to moisture (and perspiration) of various polyurethanes is discussed to illustrate the need to shift to better adhesives in preparing laminated garments.

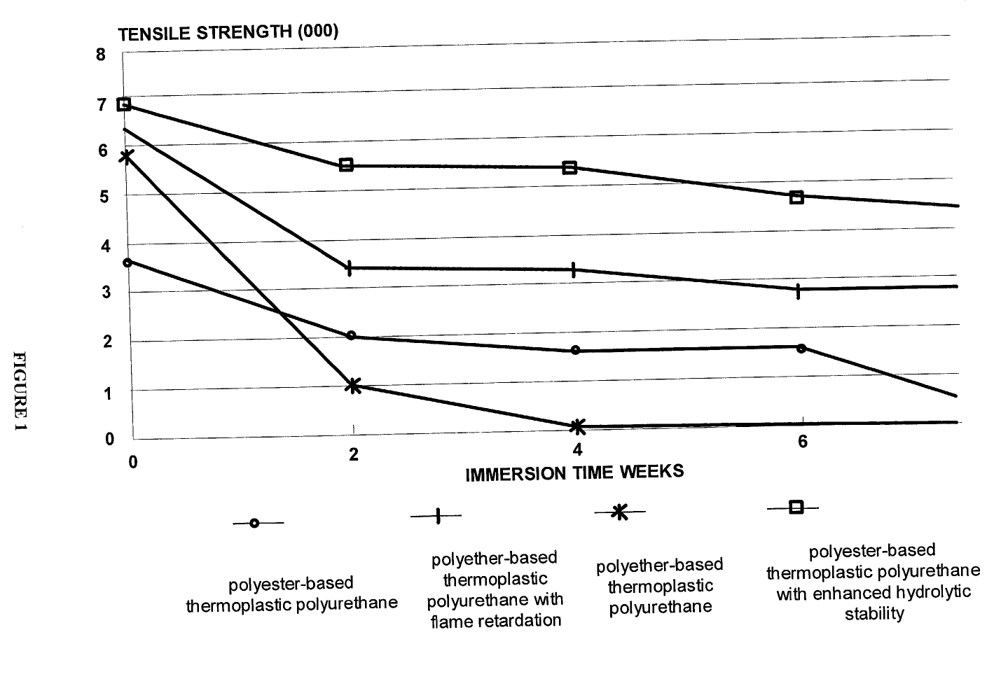

FIG. 1 illustrates measurement over time of the tensile strength of polyester-based thermoplastic polyurethane, polyester-based thermoplastic polyurethane with enhanced hydrolytic stability; polyether-based thermoplastic polyurethane with flame retardation, or polyether-based thermoplastic polyurethane respectively. The samples were tested after immersion in water at 85° C. for various periods of time to accelerate the effects of water immersion. As is readily observed, polyester-based polyurethane with enhanced hydrolytic stability was slightly better than polyether-based polyurethane while polyester-based polyurethane had the worst performance. Stability in the presence of moisture and/or perspiration is significant in garments, and undergarments in particular. Perspiration, typically present in high stress points in garments, is more corroding than moisture due to the presence of substances other than water alone.

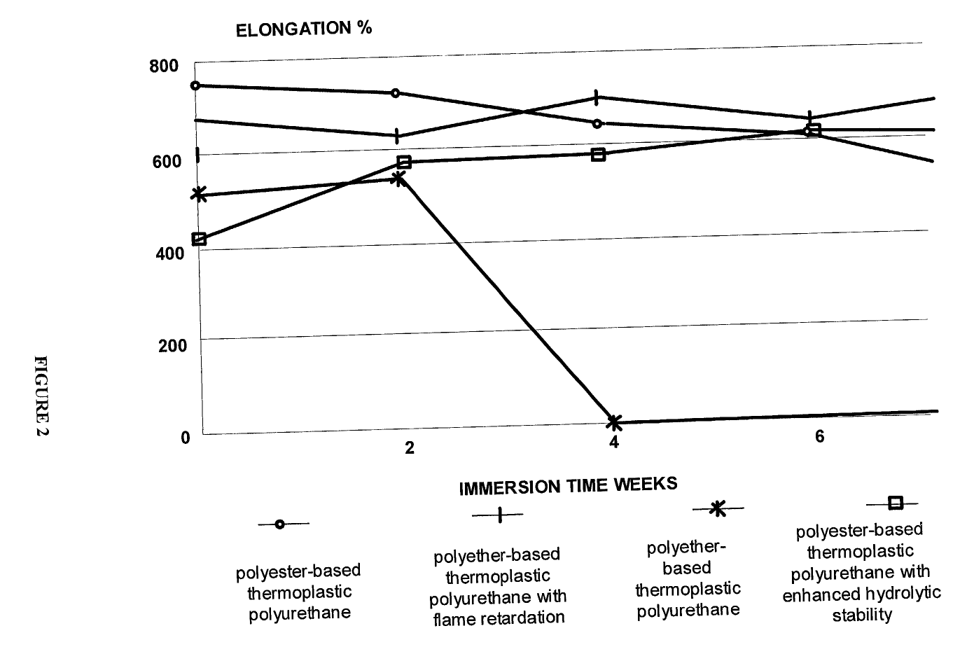

FIG. 2 illustrates changes in the elongation properties of polyester-based thermoplastic polyurethane, polyester-based thermoplastic polyurethane with enhanced hydrolytic stability; polyether-based thermoplastic polyurethane with flame retardation, or polyether-based thermoplastic polyurethane respectively. These samples were also tested after immersion in water at 85° C. for various periods of time to accelerate the effects of water immersion. As is readily observed, polyether-based polyurethanes, with or without flame retardation, performed better than polyester-based polyurethanes with polyester-based polyurethane with enhanced hydrolytic stability having only a slightly worse elongation after four weeks in water at 85° C. than the polyether-based polyurethanes.

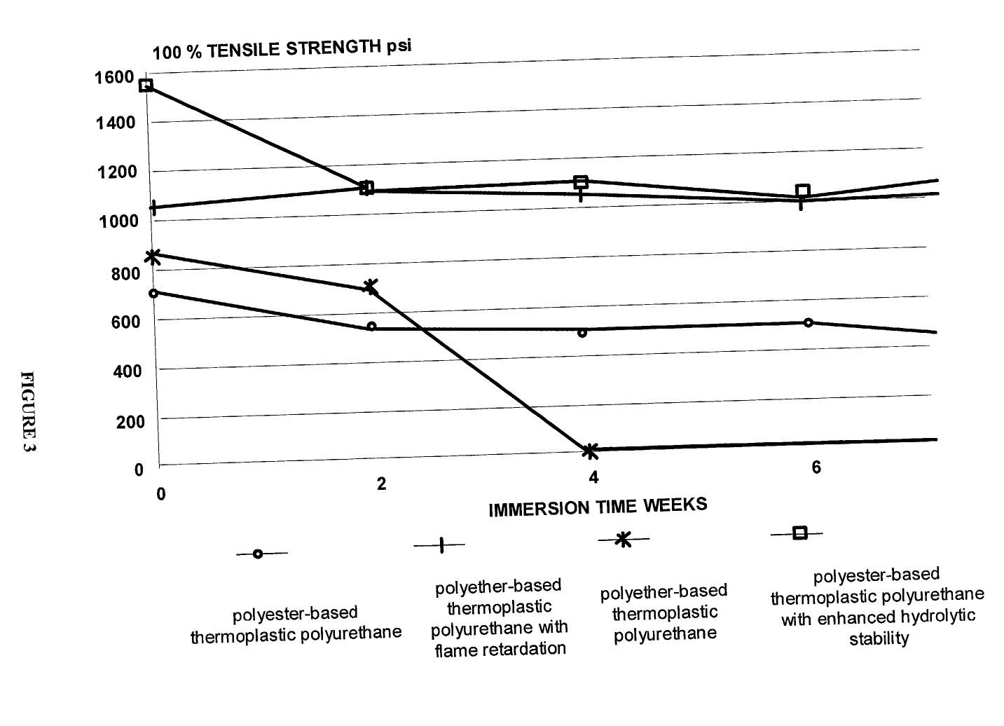

FIG. 3 illustrates measurement over time of the 100% tensile modulus of polyester-based thermoplastic polyurethane, polyester-based thermoplastic polyurethane with enhanced hydrolytic stability; polyether-based thermoplastic polyurethane with flame retardation, or polyether-based thermoplastic polyurethane respectively. These samples were also tested after immersion in water at 85° C. for various periods of time to accelerate the effects of water immersion. As is readily observed, polyester-based polyurethane again has the worst performance with polyether-based polyurethanes exhibiting stable characteristics over eight week of immersion in water. As noted in previous tests, polyester-based polyurethane with enhanced hydrolytic stability performed acceptably as well.

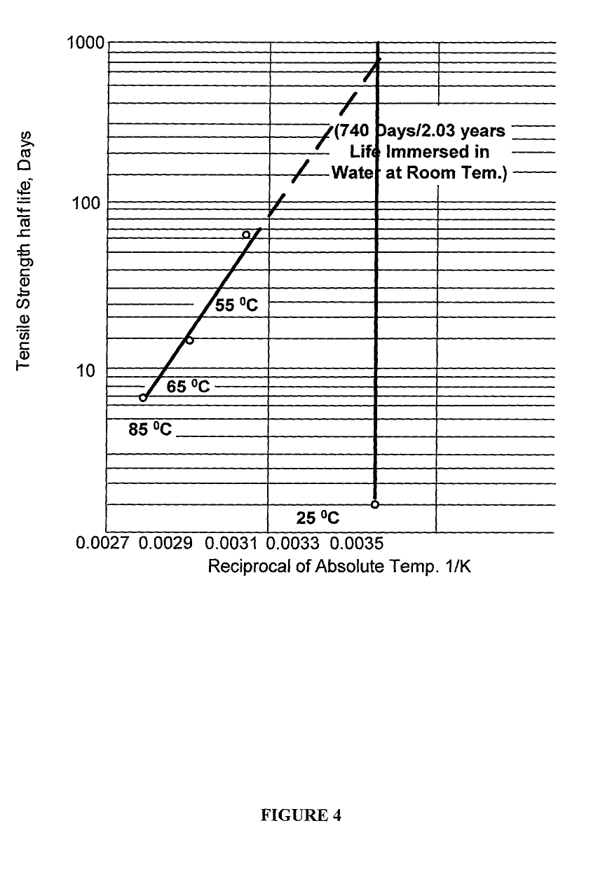

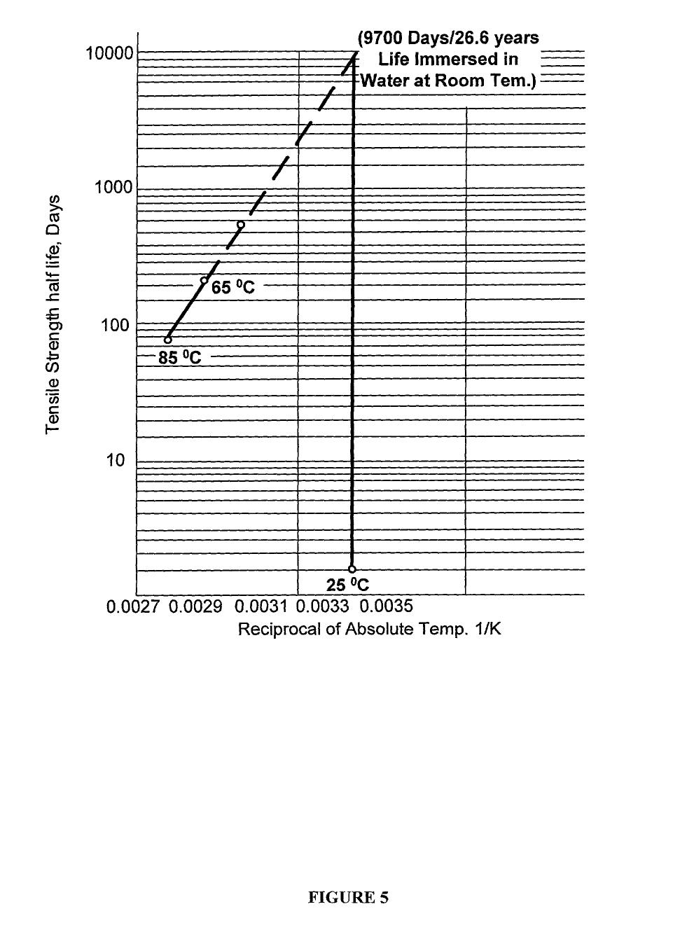

FIG. 4 is an Arrhenius plot determined by using actual water immersion data taken over various time periods and temperatures to determine when the original tensile strength of the polyester-based polyurethane material falls to 50% of the original tensile strength if the material were to be immersed in water at room temperature. FIG. 5 is a similar Arrhenius plot corresponding to polyether-based polyurethane material. As shown, polyether-based polyurethane has significantly greater resistance to hydrolysis at room temperature than polyester-based polyurethane at 9700 days compared to 740 days. These time durations are significant with respect to the expected life of a garment even without accounting for hot washes and the inevitable harsh treatment accompanying regular use.

Therefore, polyether-based polyurethanes, polyester-based polyurethane with enhanced hydrolytic stability are preferable as thermoplastic adhesives for preparing laminated garments. Advantageously, such adhesives should exhibit hydrolytic stability (measured by retention of greater than 50% of the tensile strength or similar metric) of greater than 740 days, preferably greater than 800 days, even more preferably greater than one thousand days, even more preferably greater than five thousand days and most preferably of greater than or equal to nine thousand days.

The Not-Sew™ technology enables construction of a variety of different garments, including complex garments requiring inserts, supports and wires, with a simple procedure that interfaces well with traditional manufacturing techniques. In order to attach two layers, one of the layers is prelaminated with the adhesive layer by first heating the adhesive to a softness sufficient for tacking it to the fabric layer. This tacking helps in ease of handling thin films since often the fabric layer itself is quite thin and the tacking step allows the adhesive and fabric to reinforce each other. The tacking temperature is preferably below the temperature for melting the adhesive, even more preferably at least 20° F. below the melt temperature for the adhesive film.

Following prelamination, the other layer is placed as desired on the prelaminated layer followed by application of additional heat and pressure for a defined amount of time, often termed cycle time to complete the lamination process. Naturally, the temperature for lamination is dependent on the particular adhesive film employed. Preferably, in the case of ether-based polyurethane films having thickness of less than 4 mils, the lamination temperature is about 300° F., more preferably the lamination temperature is about 350° F., and even more preferably the lamination temperature is about 375° F. These temperatures are accurate to about 20° F. It should be noted that the respective times for application of heat and pressure need not be the same. Consequently, use of a single cycle time in a described example embodiment of the invention is not intended to be a limitation on the scope of the invention. Different shaped panels can be placed in a desired manner to provide greater support or stability to particular areas. The entire garment can consist of as few as two layers.

Support for undergarments like brassieres includes padding, providing wires in sleeves known as channeling, contoured cups for imparting a desired shape and support, and the like. Providing wires for supporting breasts for increased comfort is done by inserting wires in a pair of sleeves to hold the wire securely placing it relative to the other wire accurately and firmly as well as provide padding of wire for comfort of the wearer. Naturally, this requires construction of sleeves, typically by stitching resulting in significant expense due to the need for accuracy and extensive positioning, sewing, and insertion of wires. The entire process is termed “channeling.” Similar operational details are encountered in making stiff collars for shirts and other garment shape imparting components.

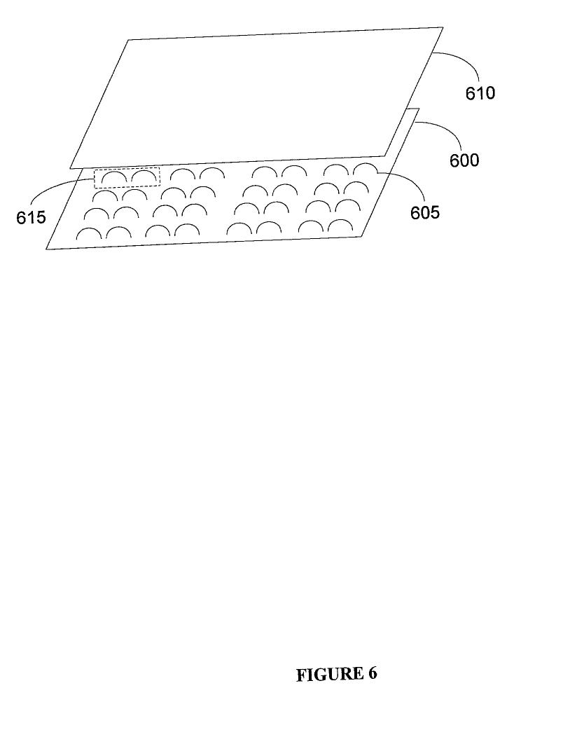

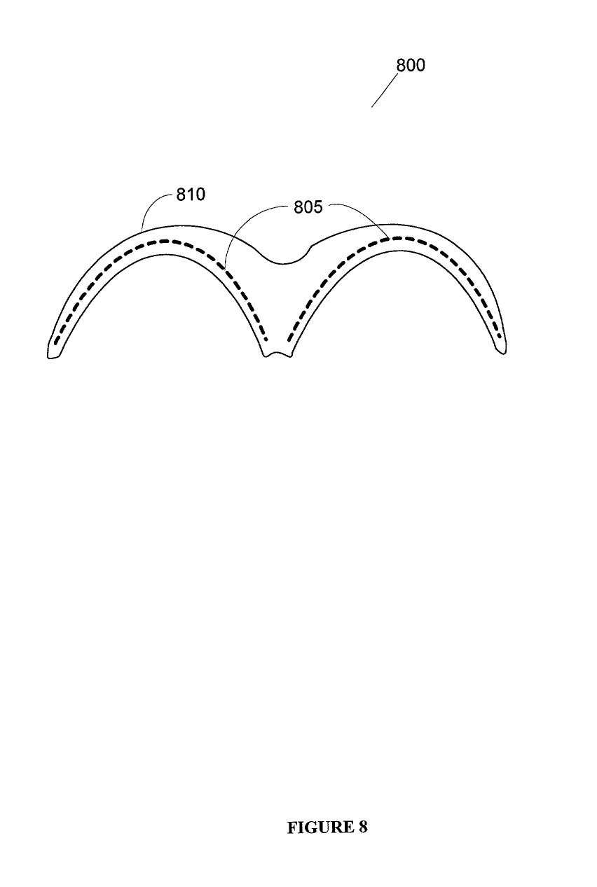

In an example embodiment of the invention, two layers of non-stretch fabric, for instance taffeta, are laminated together to create a center-front-stabilizer channeling that prevents stretching of fabric between the cups in a brassier as a substitute for aforementioned channeled wires. FIG. 6 illustrates some significant details from such an embodiment. First fabric 600 is pre-laminated with an adhesive having desirable resistance to hydrolysis. Wire 605 is placed with a desired precision to form spaced apart pairs 610 on first fabric 600 on top of the pre-laminated side of first fabric 600. Second fabric 625 is then placed on top of first fabric 600 and pressed at a predetermined temperature and pressure for the duration of a cycle-time to laminate the two fabrics. Pairs of wires enclosed in box 610 are die-cut to obtain center-front-stabilizer channeling for insertion into a brassiere. The die-cut center-front-stabilizer channeling preferably appears as shown in FIG. 8.

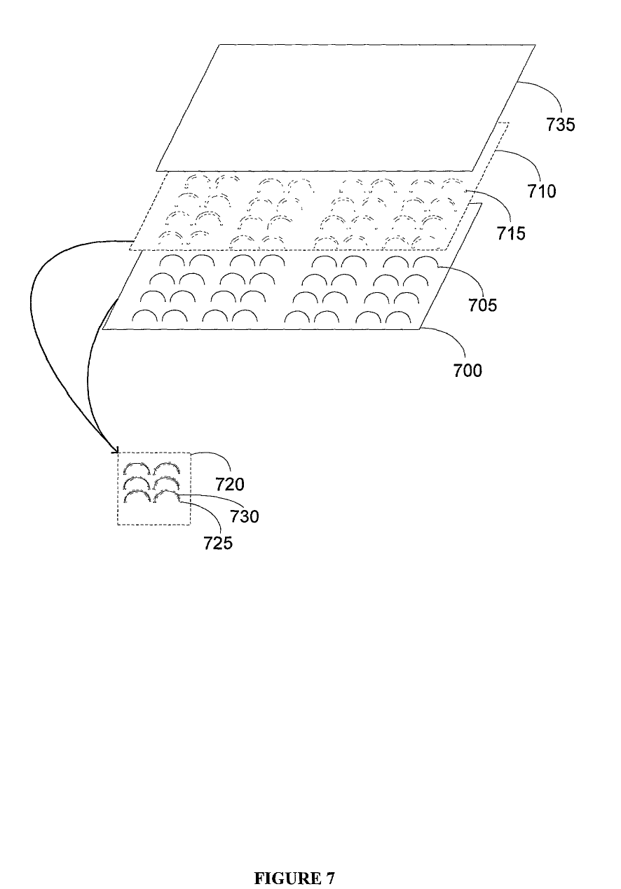

FIG. 7 illustrates one of the example methods for efficiently placing accurately spaced apart wires to make center-front-stabilizer channelings. First fabric 700 following pre-lamination with an adhesive receives wire 705 placed thereon on the pre-laminated side with the aid of setter 710 having a corresponding slot 715. A small segment of setter over first fabric 720 shows slots 725 with wires 730 placed therein. After removal of setter 710, second fabric 735 is placed on first fabric 700 to sandwich wire 705. Application of predetermined pressure, cycle-time, and temperature results in laminating first fabric 700 and second fabric 735 with the thermoplastic adhesive, preferably a thin film of polyether-based polyurethane with a known melt-point, impregnating the fibers of the fabrics.

FIG. 8 shows a typical support piece, in this case a center-front-stabilizer channeling 800, having wires or support inserts 805, for instance of metal or plastic or another stiff material, placed therein. Center-front-stabilizer channeling 800 has smooth edge 810 following a die-cut in accordance with a template from a larger laminated workpiece in a manner similar to that shown in FIGS. 6-7., although this is not a requirement of the invention since individual preformed pieces can be pre-laminated and then, following placement of wires and the like, laminated as well.

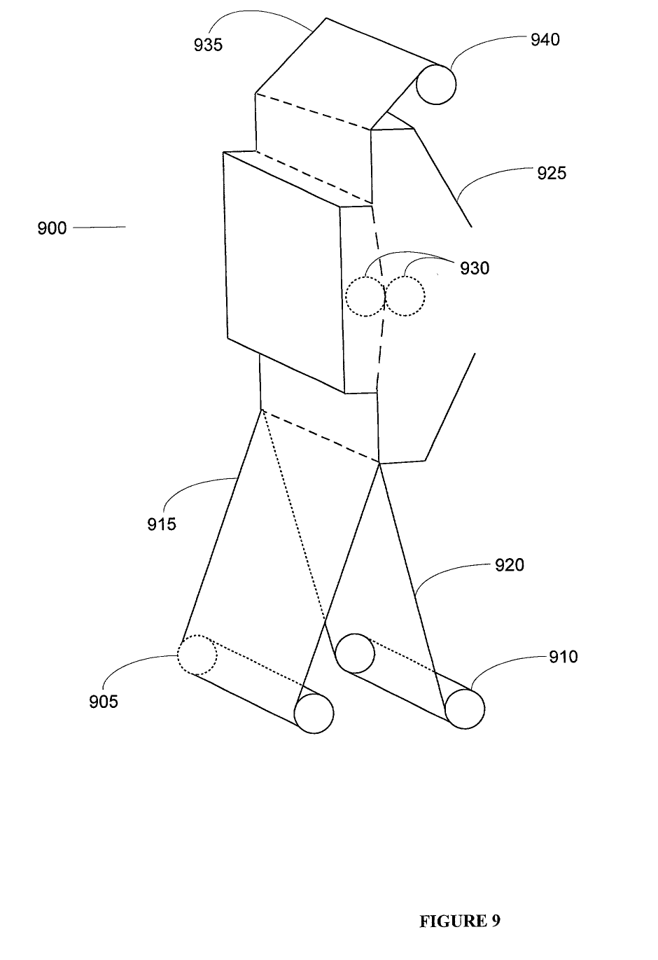

FIG. 9 illustrates an embodiment for pre-laminating fabric in accordance with the invention. Arrangement 900 includes feed roller 905, supplying a thin adhesive film 915, and feed roller 910 supplying a fabric 920. Fabric 920 and thin adhesive film 915 are fed into pre-laminating setup 925 for application of a temperature and pressure less than that required for lamination for a specified duration. This application of pressure and temperature results in ‘tacking’ thin adhesive film 915 on fabric 920 for ease in subsequent handling. In the illustrated embodiment, but not as a limitation, the pressure is applied with the aid of two surfaces 930 that may be in the form of rollers for continuous operation or opposed surfaces of a press for discontinuous operation or combinations thereof. Following tacking, pre-laminated fabric 935 is collected, for instance on roller 940 for subsequent lamination.

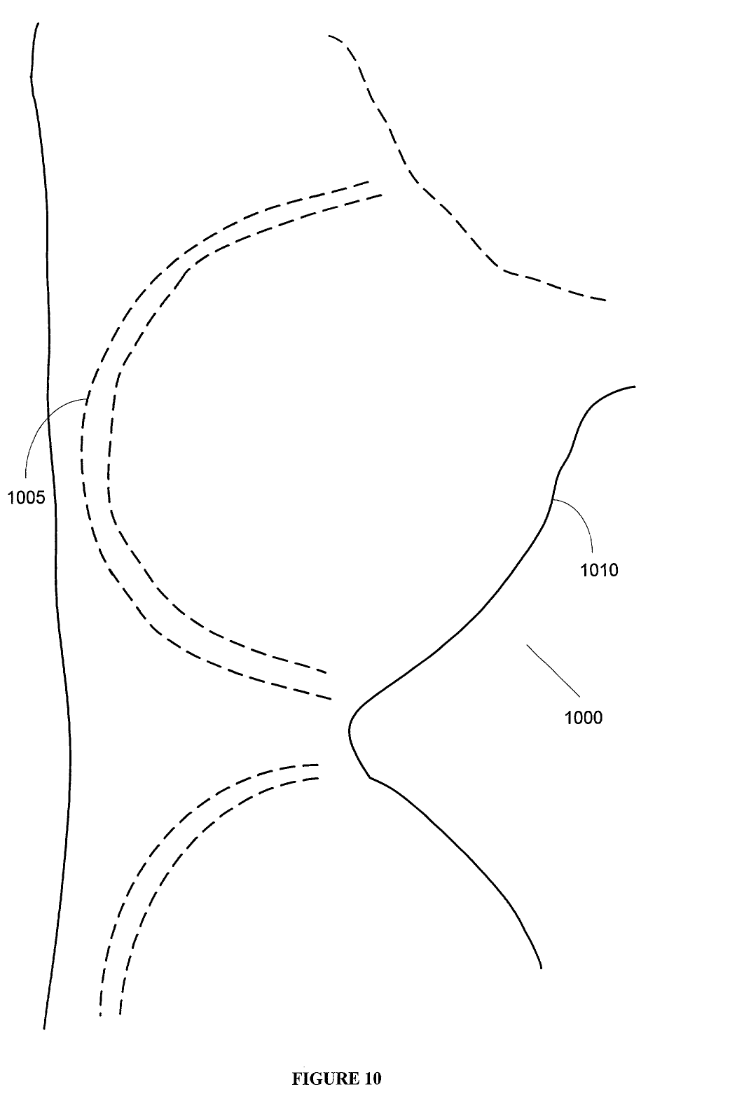

FIG. 10 shows a portion of an example brassiere manufactured in accordance with the invention. Brassiere 1000 has a support insert 1005 formed as a center-front stabilized channeling placed between two fabric layers prior to lamination. Following lamination, the cups are formed, for instance by a bubble molding process, and a die-cut produces smooth edge 1005 that is resistant to fraying despite the unfinished edge because exposed fibers therein are held by the adhesive. Additional details for manufacturing an exemplary garment are described next.

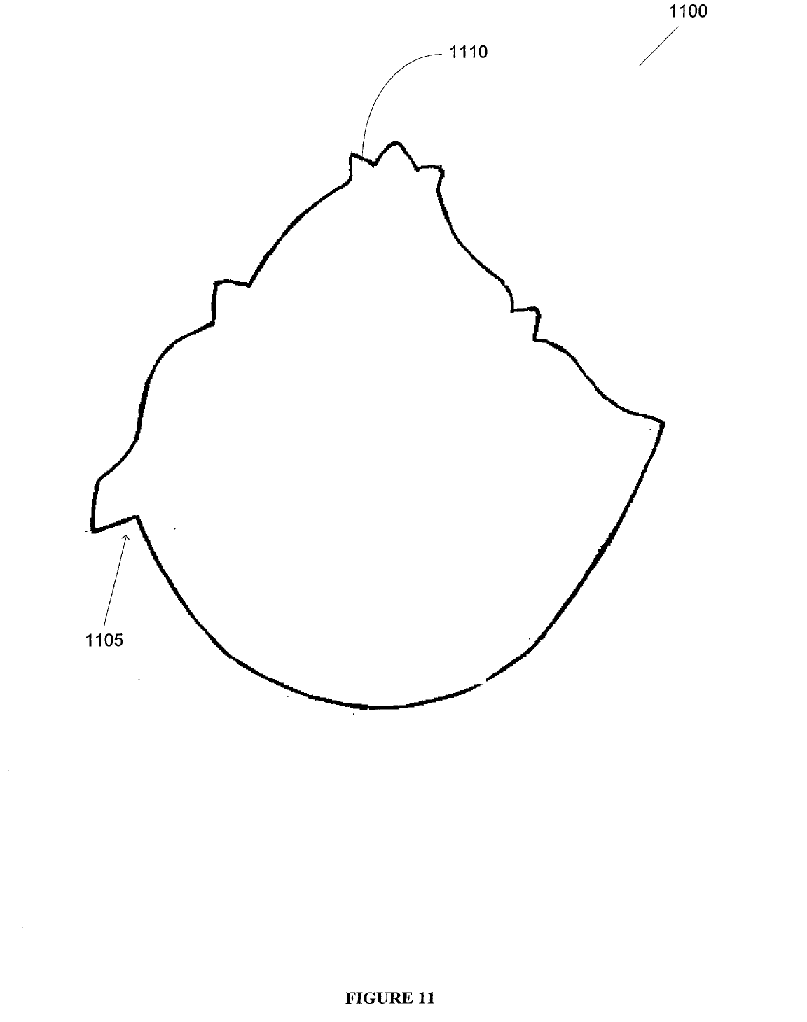

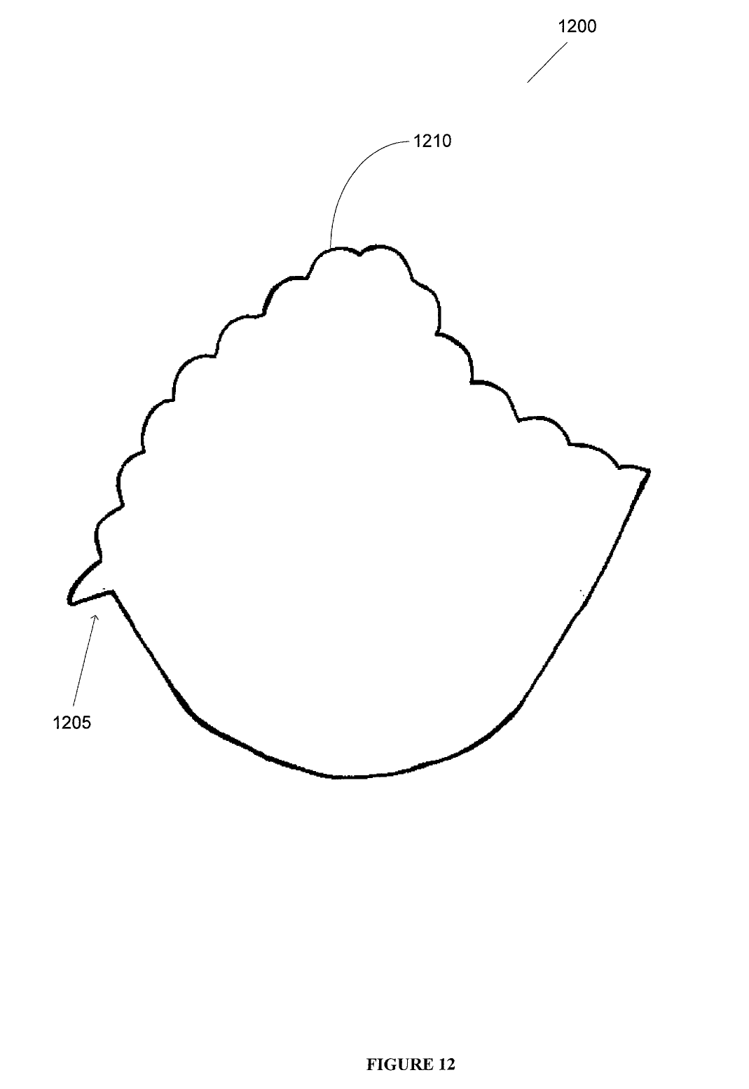

FIGS. 11 and 12 illustrate example shapes of liners in the cup area that are suitable for making bubble molded cups. The use of the illustrated cup linings has opened a new design feature by allowing creation of an embossed, or raised trim just inside the bustline. This can be ornamented by using a scalloped or other ornamentally shaped die. Since the lining does not reach to the die-cut edge of the bustline with the edge surrounding that border, between the edge of the lining and the die-cut bustline, tightly sealed with the adhesive following lamination, a well-defined, embossed edge is created by the moldable woven liner material. This strategy avoids the problems of containing the fibers of the lining because it is often too thick to be effectively held in place by the adhesive at an edge. Moreover, this results in an ornamentally cut to produce a novel and decorative feature in the form of an embossed, or raised trim just inside the bustline.

The lining patterns 1100 and 1200 respectively of FIGS. 11 and 12 are further designed to disguise the underwire channeling by placing such wires, for instance in a center-front stabilizer channeling in slots 1105 and 1205 respectively. Such placement results in greater comfort due to the lining being at the same level as the wires as well as greater aesthetic appeal. The scalloped edge in the liner for creating the embossed or raised trim is shown as 1110 and 1210 respectively.

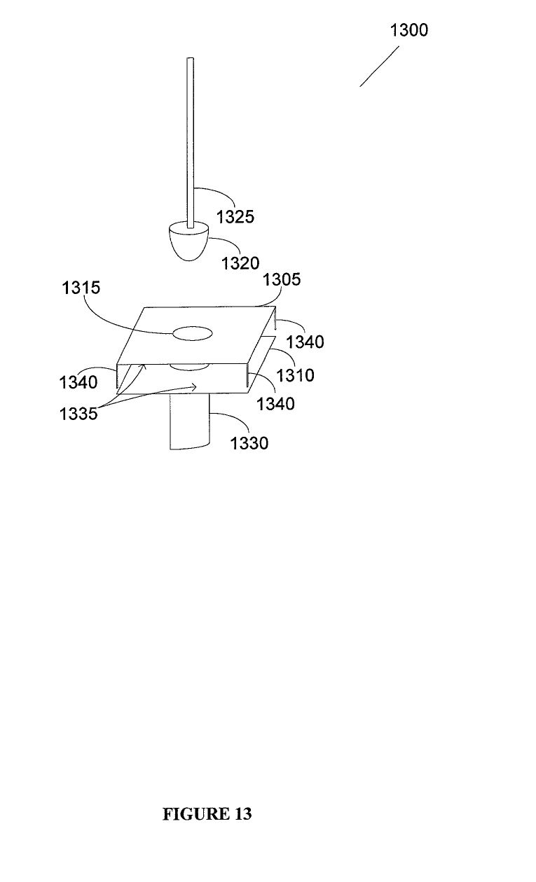

FIG. 13 illustrates some steps in the bubble molding process for creating a cup in a brassiere by application of heat and pressure. Bubble molding is a method typically used for unlined bras and is ideal for what is known as “post molding.” Post molding is basically molding a completed bra as the final stage of its production, when it has been fully assembled. A typical bubble molding machine 1300 has a top plate 1305 and bottom plate 1310 (these hold the flat bra in place clamped between the top plate 1305 and bottom plate 1310) with matching holes 1315, a “bullet” shaped heated mold 1320 , driven, e.g. via rod 1325, that comes down into the hole 1315—stretching the fabric and heating the inner cup, while a heated can 1330 below the hole, into which the bullet 1320 is pressed heats the outer layer of the cup being bubble molded as well. To ensure a firm grip and minimal, if any damage to the brassiere, the inside surfaces 1335 of the top plate 1305 and bottom plate 1310 are padded. Moreover, the top and bottom plates are aligned and guided through any one of many possible mechanisms such as the depicted pins 1340. Alternative embodiments may include lasers beams, precision machined gears and other mechanisms known in the art to ensure proper alignment between the top plate 1305 and bottom plate 1310, along with a workpiece clamped between them.

Bubble molding has not worked well with lined or padded bras. The reason for this is that bubble molding requires a great deal of stretch and give from the fabrics used, and whereas it is easy enough to find fabrics that will do this, it is not so easy to find lining or padding that will fit this criteria.

The use of a woven moldable stretch fabric allows production of a lined bra using the bubble molding method. A woven spacer fabric that, although a moldable stretch fabric, also has the thickness, and stiffness needed to meet the definition of a lined bra. Accordingly, the lining is first pre-laminated on one side with the adhesive film, cut to the desired cup shape, placed according to the garment's pattern within the “sandwich.” Since the plates on a bubble-molding machine are padded and not heated, there is no stress on the fabric around the underwires, if any, that are provided for supporting breasts encased in the cups when the brassier is being worn.

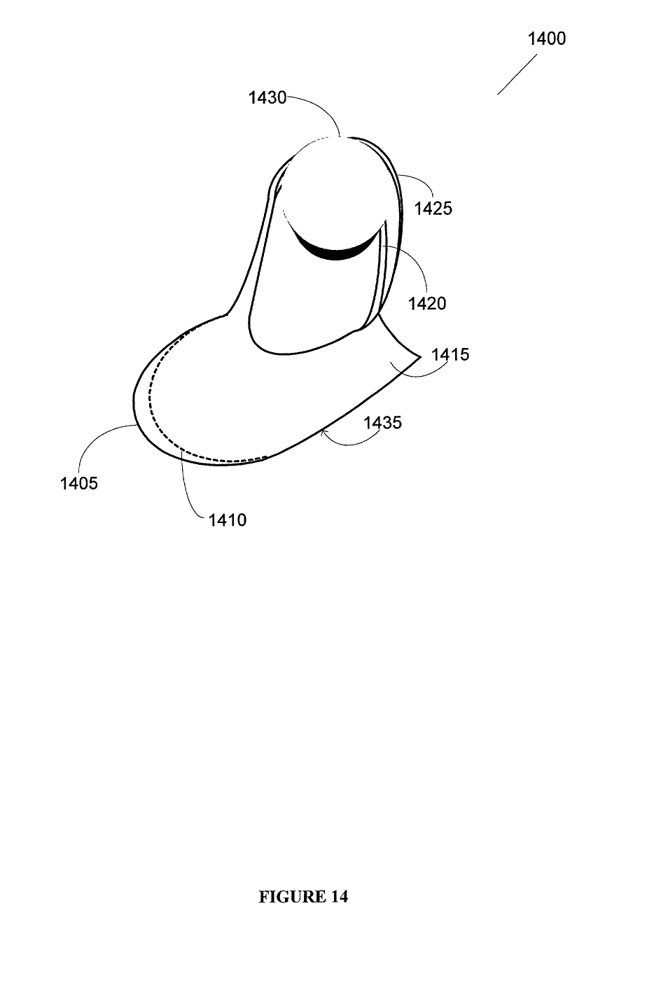

FIG. 14 illustrates an example lined brassiere 1400 with bubble molded cups 1405 and 1410, a desired soft feeling and hanger appeal, as well as unsewn edges that resist fraying. Cup 1410 is depicted by broken line to indicate that it is hidden behind cup 1405. Brassiere 1400 includes strap 1415 for gripping the torso. Strap 1415 may have a buckle, hook with complementary eye, or other gripping means including knots, or may be a closed loop to be slipped on the body of the wearer. Such means are familiar design variations and are not shown. Moreover, strap 1415 may include additional familiar design features such as twists, or neck hugging shapes by variously joining with straps 1420 and 1425. Straps 1415-1425 variously define loops for providing a grip such as around the shoulders, arms, neck, torso, chest and the like of the wearer in various more detailed and specific embodiments of the invention. In addition, brassiere 1400 can be combined with matching panties and other undergarments to match colors, texture, design, or even the laminated seamless edge finish. Typically, such additional undergarments may wrap around additional body parts such as a leg or thigh. Such combinations include brassiere 1400 being part of a one piece design as in familiar one-piece swimsuits.

Brassiere 1400 is illustrated as placed over support 1430 with the cups substantially retaining their shape without assistance or fillers to provide hanger appeal by more realistically indicating their appearance when worn. It is possible to fashion cups for brassieres in all size ranges from the industry standard description 32 A through D to 38 A through D and even larger sizes to 44 A through D. Here cup size is indicated by the alphabetical suffix chosen from A, B, C, and D with D representing the largest cup size and A representing the smallest cup size customarily made. In addition, edge 1435 of the brassiere 1400 is lacking sew lines enhancing comfort and visual appeal.

Although the invention can be utilized to make a variety of different garments of greater or lesser complexity, the general method and applications remain the same. That is, two or more layers of fabrics (or other components, such as underwires) are laminated together with layer(s) of adhesive in between, using heat and pressure to soften the adhesive and press it into the fibers of the material. Different shaped panels can be pre-cut and positioned to provide greater support or stability to needed areas, or the entire garment may simply consist of two or more layers which are first laminated and then cut to the desired shape.

At this point, garments may be modified further by molding (such as with bra cups), by using ultrasonic or radio-frequency seals (such as for attaching straps), or even by sewing (for joining ends).

To address the process in greater detail, the step-by-step manufacturing of a brassiere, similar to that shown in FIG. 10, from start to finish in described in an embodiment of the invention.

Fabrics are selected that a) have two-way stretch, b) are moldable, c) are not treated with dyes or softeners that will inhibit the adhesive, and d) fabrics to be laminated together have like physical properties compatible with being laminated together. The ‘like physical properties’ is not a limitation on the scope of the invention but merely a detail in this embodiment so that when the fabrics are stretched, molded, etc., they will act together and not put unnecessary strain on the adhesive.

Tests are then run to determine the optimum thickness and melt-point of the film, in order to create the best bond and least strain (from heat of the laminating process) for said fabric(s). The main components of the N-S bra are the inner and outer layers of fabric; these act as a kind of sandwich for the majority of the other components (such as underwires, channeling, padding, stabilizing, and support fabrics, etc.). The inner side of one of these fabrics, as well as one side of all components to be placed within the “sandwich, is pre-laminated with the desired adhesive.”

Pre-lamination is a process whereby the N-S film adhesive, typically an ether-based polyurethane film, preferably 1 to 1.5 mils (thousandths of an inch) thick is tacked to the fabrics to be used. The tacking is accomplished by using a lower temperature and less pressure than that of the actual laminating to avoid loss of the adhesive in the fibers of the fabric while allowing for easier handling of both adhesive and fabrics. Many fabrics are thin and susceptible to damage by excessive heat. Thus, tacking a thin adhesive film results in the combination being stronger and easier to handle in addition to providing better control over the subsequent lamination process itself. In this regard it should be noted that often adhesives lack a well defined melting point since they are similar to glasses and tend to soften progressively with increasing temperature. Consequently, the temperature for pre-laminating can be advantageously empirically determined to suit a particular fabric and production setup within the scope of the invention.

With pre-lamination completed, any components (pads, stabilizers, channeling) to be placed within the “sandwich” are die-cut or slit to the proper size/shape. In the case of channeling, underwires are inserted into the channels and sealed. The outer fabrics (both the pre-laminated and the non-laminated) are often cut into sheets corresponding in size to the bra patterns (three or four or even more can be cut from a single sheet). The bottom sheet (pre-laminated) is placed (adhesive side up) on the bed of the laminating press (a pressurized press with both top and bottom heated plates) using a system of pins and holes, which have been pre-located on the comers of the sheets. Using lasers to locate the proper placement, the internal components are placed upon the sheet (adhesive side up as well).

The top sheet is placed on top using the same system of pins and holes. The “sandwich” is then laminated corresponding to the temperature, cycle-time, and pressure designated by the previous testing. Using a “bubble molding” machine, the cups of the bra are molded to the proper circumference to complete the manufacturing process.

The invention provides a practical and cost effective method and system to manufacture laminated garments with a comfortable seamless finish and reduced visibility under tight-fitting clothing. The unfinished edges do not exhibit fraying resulting in even displacement of pressure against the skin of the wearer and even greater comfort than other seamless garments. Moreover, the disclosed manufacturing techniques are more efficient and less costly than traditional sewing techniques. In addition, use of sewing to add loops, belts, straps and other additions to a laminated garment or portion thereof prepared in accordance with the invention allows the invention to synergistically extend the range of methods and technologies for manufacturing garments.

Advantageously, an adhesive made in the form of a film provides more consistent physical properties than webs, powders, or liquid adhesives. This, naturally, is of significance in imparting resistance to delamination and fraying, the peeling apart of laminated surfaces. Moreover, an adhesive made from ether-based polyurethane (versus the known untreated ester-based polyurethane resins) is superior to previously employed adhesives. The disclosed cycle-time, temperature and pressure engineered processes (both adhesive and machinery) optimize adhesion, stretch, breathability, and longevity of garment manufactured in accordance therewith.

The disclosed method and system teach producing garments without, or with reduced amounts of, traditional sewing techniques. In lieu of sewing, fabrics are joined using a laminating process that is superior due to its unique adhesive and manufacturing process. It is particularly applicable to the manufacturing of intimate apparel (bras, panties), shapewear, and activewear, which because of their complex construction—that often need to withstand much more stretch than other garments—typically requires a great deal of bulky and expensive stitching.

Alternative means for placing or aligning fabrics, the order of cutting the fabrics and other similar details are not intended to be limiting in the described embodiments that are primarily intended to be illustrative.

It will be appreciated that the various features described herein may be used singly or in any combination thereof. Thus, the present invention is not limited to only the embodiments specifically described herein. While the foregoing description and drawings represent a preferred embodiment of the present invention, it will be understood that various additions, modifications, and substitutions may be made therein without departing from the spirit and scope of the present invention as defined in the accompanying claims. In particular, it will be clear to those skilled in the art that the present invention may be embodied in other specific forms, structures, and arrangements, and with other elements, and components, without departing from the spirit or essential characteristics thereof. One skilled in the art will appreciate that the invention may be used with many modifications of structure, arrangement, and components and otherwise, used in the practice of the invention, which are particularly adapted to specific environments and operative requirements without departing from the principles of the present invention. The presently disclosed embodiment is therefore to be considered in all respects as illustrative and not restrictive, the scope of the invention being indicated by the appended claims, and not limited to the foregoing description.

We claim:

1. A fabric laminate comprising at least a first fabric, a second fabric and a heat sensitive adhesive layer; the adhesive layer pre-laminated on the first fabric in the form of a film tacked on the first fabric by application of pressure and temperature less than that required for lamination followed by placement of the adhesive layer between opposed surfaces of the first and second fabrics for adhesively securing said first and second fabrics together along their opposed surfaces in a lamination step by positioning the second fabric on the pre-laminated first fabric and applying sufficient pressure and temperature.

2. The fabric laminate of claim 1 further including a woven moldable stretch fabric suitable for bubble molding a cup by application of sufficient heat and pressure to an identified area of the fabric laminate.

3. The fabric laminate of claim 2 wherein the woven stretch fabric material isa synthetic fabric.

4. The fabric laminate of claim 1 further including at least one cup.

5. The fabric laminate of claim 1 further having a plurality of edges wherein at least one edge from the plurality of edges has a laminated finish following a die-cutting operation, wherein furthermore, the laminated finish does not require additional finishing with the aid of sewing.

6. The fabric laminate of claim 5 wherein the at least one edge having a laminated finish is treated with a hot surface following the die-cutting operation to smooth out fraying fibers created by the die-cutting operation.

7. The fabric laminate of claim 1 further including a plurality of openings wherein at least one opening from the plurality of openings is suitable for placing therein at least one member of the set consisting of a human arm, a human shoulder, a human torso, a human thigh, a human neck, and a human leg.

8. The fabric laminate of claim 1 wherein the adhesive layer is a film having a thickness of less than or equal to about 20 mil.

9. The fabric laminate of claim 8 wherein the thickness of the adhesive layer is between about 0.5 mil and about 20 mil.

10. The fabric laminate of claim 9 wherein the thickness of the adhesive layer is between about 0.5 mil and about 2.0 mil.

11. The fabric laminate of claim 10 wherein the thickness of the adhesive layer is between about 1.0 mil and about 1.5 mil.

12. The fabric laminate of claim 8 wherein the thickness of the adhesive layer is about 4.0 mil.

13. The fabric laminate of claim 8 wherein the thickness of the adhesive layer is about 6.0 mil.

14. The fabric laminate of claim 1 wherein the adhesive layer comprises ether-based polyurethane.

15. The fabric laminate of claim 14 wherein the adhesive layer comprises at least 50% ether-based polyurethane.

16. The fabric laminate of claim 15 wherein the adhesive layer comprises at least 90% ether-based polyurethane.

17. The fabric laminate of claim 16 wherein the adhesive layer comprises at least 99% ether-based polyurethane.

18. The fabric laminate of claim 1 wherein the adhesive layer comprises treated ester-based polyurethane.

19. The fabric laminate of claim 18 wherein the adhesive layer comprises at least 50% ester-based polyurethane.

20. The fabric laminate of claim 19 wherein the adhesive layer comprises at least 90% ester-based polyurethane.

21. The fabric laminate of claim 20 wherein the adhesive layer comprises at least 99% ester-based polyurethane.

22. The fabric laminate of claim 1 wherein the adhesive layer has a hydrolytic stability of at least 740 days.

23. The fabric laminate of claim 1 wherein the adhesive layer has a hydrolytic stability of at least 1000 days.

24. The fabric laminate of claim 1 wherein the adhesive layer has a hydrolytic stability of at least 5000 days.

25. The fabric laminate of claim 1 further including at least one insert held between the prelaminated first fabric and the second fabric by sandwiching the at least one insert between the first fabric and the second fabric followed by lamination of the first fabric to the second fabric.

26. The fabric laminate of claim 25 wherein the at least one insert is a wire shaped to provide support to at least one breast of a wearer of a garment.

27. A brassiere for providing support to at least one breast of a wearer, the brassier comprising:
at least two layers that are laminated together by an adhesive layer between them by application of heat and pressure;
a third layer of woven, stretch fabric placed in an area suitable for bubble molding such that the third layer, having an adhesive layer prelaminated thereon, is sandwiched between the at least two layers;
at least one cup formed by a bubble molding process such that the at least two layers and the third layer in the area suitable for bubble molding are shaped into a cup having a desired size by the application of pressure via a bubble molding setup; and
at least one unsewn edge finished by lamination only whereby eliminating look and feel of a sewn finish

28. The brassiere of claim 27 further having at least one strap cushioned by laminating a woven, stretch fabric between the at least two layers in an area suitable for forming a strap.

29. The brassiere of claim 27 wherein the adhesive layer is applied to one of the at least two layers in a prelaminating step at a temperature and pressure to make the adhesive layer tacky without melting followed by contacting another layer of the at least two layers to the prelaminated layer and laminating at sufficient temperature and pressure to melt the adhesive into the fibers of the at least two layers.

30. The brassier of claim 27 further including at least one wire in association with the at least one cup.

31. The brassiere of claim 27 wherein the at least one cup provides hanger appeal by substantially retaining its shape without requiring a filler or support material.

32. The brassiere of claim 27 wherein the adhesive layer has a thickness of less than or equal to about 20 mil.

33. The brassiere of claim 32 wherein the thickness of the adhesive layer is between about 0.5 mil and about 2.0 mil.

34. The brassiere of claim 33 wherein the thickness of the adhesive layer is between about 1.0 mil and about 1.5 mil.

35. The fabric laminate of claim 27 wherein the adhesive layer comprises ether-based polyurethane.

36. The brassiere of claim 35 wherein the adhesive layer comprises at least 50% ether-based polyurethane.

37. The brassiere of claim 35 wherein the adhesive layer comprises at least 90% ether-based polyurethane.

38. The brassiere of claim 36 wherein the adhesive layer comprises at least 99% ether-based polyurethane.

39. The brassiere of claim 27 wherein the adhesive layer comprises treated ester-based polyurethane.

40. The brassiere of claim 39 wherein the adhesive layer comprises at least 50% ester-based polyurethane.

41. The brassiere of claim 39 wherein the adhesive layer comprises at least 90% ester-based polyurethane.

42. The brassiere of claim 39 wherein the adhesive layer comprises at least 99% ester-based polyurethane.

43. The brassiere of claim 27 wherein the adhesive layer has a hydrolytic stability of at least 740 days.

44. The brassiere of claim 27 wherein the adhesive layer has a hydrolytic stability of at least 1000 days.

45. The brassiere of claim 27 wherein the adhesive layer has a hydrolytic stability of at least 5000 days.

46. The brassier of claim 27 wherein the cup size is at least A and at the most D.

47. The brassiere of claim 46 further being part of a matched set of undergarments including at least one pair of panties.

48. An insert for providing support to a brassiere by providing support and defining to at least two cups placed in the brassiere, the insert comprising:
a bottom layer that is initially prelaminated with an adhesive layer by contacting them at a temperature and pressure that is not sufficient to completely melt the adhesive;
a set of precisely placed wire inserts to define the separation between the cups in a brassiere;
a top layer, made from a stretch resistant fabric, placed on the prelaminated side of the bottom layer so as to sandwich the wire inserts between the top and the bottom layers following lamination of the top and bottom layers by application of a pressure and temperature sufficient to melt the adhesive for a prescribed cycle time; and
a shape formed by diecutting the laminated top and bottom layers to yield the insert having two appropriately spaced apart wires.

49. A method of manufacturing a laminated garment, the method comprising the steps of:
determining a melt temperature of an adhesive layer;
selecting a tacking temperature below the melt temperature;
placing the adhesive layer on a first fabric layer;
applying a tacking pressure and the tacking temperature to the adhesive layer and the first fabric layer to generate a first prelaminated fabric layer;
placing the first prelaminated fabric layer against a second fabric layer in a defined area such that the adhesive layer is between the first fabric layer and the second fabric layer to form a sandwich in the defined area;
applying a lamination pressure for a pressure cycle time to the sandwich;
applying a lamination temperature for a temperature cycle time to the sandwich such that the lamination temperature is not less than the melt temperature of the adhesive layer; and
shaping the laminated garment.

50. A method for manufacturing a laminated garment of claim 49 further including the step of diecutting the laminated sandwich to shape the laminated garment.

51. A method for manufacturing a laminated garment of claim 50 further including the step of finishing the edges following the step of diecutting with a hot surface to contain fraying fibers generated by the diecutting step.

52. A method for manufacturing a laminated garment of claim 49 wherein the pressure cycle time and the temperature cycle time are synchronized.

53. A method for manufacturing a laminated garment of claim 49 wherein the pressure cycle time and the temperature cycle time are not synchronized.

54. A method for manufacturing a laminated garment of claim 49 further including the step of selecting a hydrolysis resistant adhesive for the adhesive layer such that the adhesive has a hydrolysis stability of at least 740 days.

55. A method for manufacturing a laminated garment of claim 49 further including the step of selecting a hydrolysis resistant adhesive for the adhesive layer such that the adhesive has a hydrolysis stability of at least 1000 days.

56. A method for manufacturing a laminated garment of claim 49 further including the step of selecting a hydrolysis resistant adhesive for the adhesive layer such that the adhesive has a hydrolysis stability of at least 5000 days.

57. A method for manufacturing a laminated garment of claim 49 further including the step of selecting an ether-based polyurethane adhesive for the adhesive layer such that the adhesive comprises at least 50% ether-based polyurethane.

58. A method for manufacturing a laminated garment of claim 49 further including the step of selecting an ether-based polyurethane adhesive for the adhesive layer such that the adhesive comprises at least 90% ether-based polyurethane.

59. A method for manufacturing a laminated garment of claim 49 further including the step of selecting an ether-based polyurethane adhesive for the adhesive layer such that the adhesive comprises at least 99% ether-based polyurethane.

60. A method for manufacturing a laminated garment of claim 49 further including the step of selecting a treated ester-based polyurethane adhesive exhibiting substantially higher resistance water damage than untreated ester-based polyurethane.

61. A method for manufacturing a laminated garment of claim 49 wherein the first fabric layer and the second fabric layer have an additional fabric layer between them outside of the defined area.

62. A method for manufacturing a laminated garment of claim 49 wherein the additional fabric layer is prelaminated with the adhesive layer.

63. A method of molding a cup in a laminated garment, the method comprising the steps of:
placing a woven moldable stretch fabric between a prelaminated first fabric, the prelaminated first fabric having tacked on a first fabric a layer of adhesive, and a second fabric to create a pre-bubble mold assembly;
laminating the pre-bubble mold assembly by applying sufficient pressure and temperature for a cycle time;
placing the laminated pre-bubble mold assembly in a bubble molding assembly between padded holding first and second plates; and
applying heat in a bin connected to the first plate via a first hole; and applying heat and pressure via a plunger pressed through an opening aligned with a second hole in the second plate that is aligned with the first hole.

64. The method of molding a cup in a laminated garment of claim 63 further comprising the step of selecting a plunger shape corresponding to a desired size and shape for the cup.

65. The method of molding a cup in a laminated garment of claim 63 wherein the plunger creates a cup size less than a D size.

66. The method of molding a cup in a laminated garment of claim 63 wherein the plunger creates a cup size of at least an A size.

67. The method of molding a cup in a laminated garment of claim 63 further comprising shaping, prior to bubble molding, the woven moldable stretch fabric to have an embossed trim just inside a bustline corresponding to the cup.

68. The method of molding a cup in a laminated garment of claim 63 further comprising shaping, prior to bubble molding, the woven moldable stretch fabric with an ornamentally shaped die.

69. The method of molding a cup in a laminated garment of claim 68 wherein the die is scalloped.

70. The method of molding a cup in a laminated garment of claim 63 further comprising shaping, prior to bubble molding, the woven moldable stretch fabric to form a slot.

71. The method of molding a cup in a laminated garment of claim 70 further comprising shaping, prior to bubble molding, the woven moldable stretch fabric slot to receive a wire insert adjacent to the woven moldable stretch fabric.

72. The method of molding a cup in a laminated garment of claim 71 wherein the woven moldable stretch fabric is a spacer fabric shaped to adjacently receive a center-front stabilizer channelling.

73. The method of molding a cup in a laminated garment of claim 71 wherein the woven moldable stretch fabric is a spacer fabric shaped to adjacently receive a channeling.
